(19) United States
(12) Patent Application Publication
(10) Pub. No.: US 2014/0095200 A1
(43) Pub. Date: Apr. 3, 2014

(54) RAPID IDENTIFICATION OF DENTAL PROSTHESES

(71) Applicant: ELLEN M. BOSTOCK, RICHMOND, VA (US)

(72) Inventor: ELLEN M. BOSTOCK, RICHMOND, VA (US)

(21) Appl. No.: 14/031,024

(22) Filed: Sep. 18, 2013

Related U.S. Application Data
(60) Provisional application No. 61/708,190, filed on Oct. 1, 2012.

(51) Int. Cl. G06F 19/00; G06K 1/12; A61C 13/00

(52) U.S. Cl. CPC G06F 19/322; A61C 13/00; G06K 1/12
USPC 705/3; 156/280

(57) ABSTRACT

The invention provides ownership identification and manufacturing data of removable or fixed dental prostheses or appliances. This is achieved through the embedding of a unique high resolution 2D Code and 5 digit alpha-numeric identification number printed with a high contrast ink on a translucent adhesive material. The insertion of the 2D Code and identification number is achieved via etching a rectangular indentation in the removable prosthesis with an acceptable Dental Laboratory etching device and securing/protecting it with a clear autopolymerizing acrylic resin. If the dental prosthesis is too small to accommodate the 2D Code and/or Identification Number, an Identification Card is also provided containing an identical Code & Identification Number.

### CROSS-REFERENCE TO RELATED APPLICATIONS

This application claims priority to U.S. Provisional Application Ser. No. 61/708,190, filed Oct. 1, 2012, the contents of which are incorporated herein by reference in its entirety.

### FIELD OF THE INVENTION

The present invention relates to identification systems and methods.

### BACKGROUND

Many U.S. states have mandatory requirements for denture identification to assist in the repair or replacement of a dental prosthesis or appliance. A current technologically secure means of identifying ownership and providing data to assist in the repair or replacement of a dental prosthetic or appliance is necessary to meet the mandatory state requirements for denture identification. In addition, many states have requirements for disclosing prosthetic material and identifying point-of-origin to the patient.

### BRIEF SUMMARY

In one embodiment of the invention, a method for storing and accessing information corresponding to a dental prosthesis comprises defining a cavity in a surface of a dental prosthesis, placing a label within the cavity, the label having at least one unique identifying insignia printed thereon, applying a clear resin over the label, and curing the applied resin. Defining a cavity within a surface of a dental prosthesis comprises etching a cavity in a previously manufactured dental prosthesis or forming a cavity during manufacture of a dental prosthesis. The at least one unique identifying insignia corresponds to a data record specific to the dental prosthesis stored in a secure database.

The at least one unique identifying insignia may comprise a first unique identifying insignia that is machine-readable and a second unique identifying insignia that is human-readable. The first and second unique identifying insignia may both correspond to the data record specific to the dental prosthesis.

The first identifying insignia may comprise a 2D code, and the second identifying insignia may comprise an alphanumeric string.

The method may further comprise reading the first unique identifying insignia with a scanning device adapted to communicate, directly or indirectly, with the secure database to access the data record specific to the dental prosthesis corresponding to the first and second unique identifying insignia.

The data record specific to the dental prosthesis may comprise first tier data and second tier data. Reading the first unique identifying insignia with a scanning device adapted to communicate, directly or indirectly, with the secure database may enable access only to the first tier data. The method may further comprise correctly answering one or more predefined security questions to access the second tier data.

The method may further comprise accessing a website adapted to communicate, directly or indirectly, with the secure database containing the data record specific to the dental prosthesis corresponding to the first and second unique identifying insignia, and entering the second unique identifying insignia to access the data record specific to the dental prosthesis corresponding to the first and second unique identifying insignia.

The data record specific to the dental prosthesis may comprise first tier data and second tier data. Entering the second unique identifying insignia may enable access only to the first tier data. The method may further comprise correctly answering one or more predefined security questions to access the second tier data.

The method may further comprise providing an identification card having a same at least one unique identifying insignia printed thereon.

In addition to the method for identifying dental prostheses, as described above, other aspects of the present invention are directed to corresponding systems and computer program products for identifying dental prostheses.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1A and 1B show a label having a 2D Code & Identification Number at approximate actual size (FIG. 1A) and enlarged size (FIG. 2B), in accordance with embodiments of the present invention.

FIGS. 2A and 2B show the 2D Code & Identification Number of FIGS. 1A and 1B embedded into a dental prosthetic, in accordance with embodiments of the present invention.

FIG. 3 shows an exemplary representation of data corresponding to a dental prosthesis displayed on a smart phone after the 2D Code on the dental prosthesis is scanned and access to a corresponding data record is gained, in accordance with embodiments of the present invention.

FIG. 4 shows a general representation of how scanning a 2D Code on a dental prosthesis enables access to and display of a corresponding data record, in accordance with embodiments of the present invention.

FIG. 5 shows an exemplary Identification Card, in accordance with embodiments of the present invention.

FIG. 6 shows a process of accessing data corresponding to a dental prosthetic, accordance with embodiments of the present invention.

FIG. 7 shows a process of entering data corresponding to a dental prosthetic, accordance with embodiments of the present invention.

FIG. 8 is a schematic block diagram of a computer network in which embodiments of the present invention may operate.

FIG. 9 is a diagram of the internal structure of a computer in the computer network of FIG. 7.

### DETAILED DESCRIPTION

Embodiments of the invention provide systems, methods, and computer program products to provide dental prosthesis identification. Embodiments of the invention will be referred to herein as the “DPid Identification System and Method.” The DPid Identification System and Method is a reliable and rapid source for providing an economical, single source for patients, dentists, and dental laboratories to access secure data listing the materials and components used in the manufacturing of a dental prosthetic, thereby eliminating the guess-work and expense in repairing and remanufacturing and thus reducing overall turnaround time and expense. The DPid Identification System and Method also assist dentists and dental laboratories in meeting government standards by providing applicable certifications, traceability, and accountability for the devices they provide. In addition to providing a discrete form of owner identification and preserving the patient's self-image, by providing an open line of communication between the patient, dentist, and dental laboratory to insure the patient's wellbeing and smile, both inside and outside, can be restored quickly in the event of loss or damage of the dental prosthetic. The DPid Identification System and Method may be used for tracking and identification of any type of dental appliance, prosthetic, or the like, including, but not limited to, removable or mechanically attached dentures, removable or mechanically attached partial dentures, athletic mouth-guards, crowns, and bridges (all such dental products shall be generically referred to herein as “dental prosthetic”).

Several advantages of one or more aspects of embodiments of the present invention are as follows: to provide rapid access to a secure, concise database via the internet through a common reader app that displays the materials, components, certifications, government standards, and other related data required to repair, remanufacture, or identify a dental prosthesis or appliance.

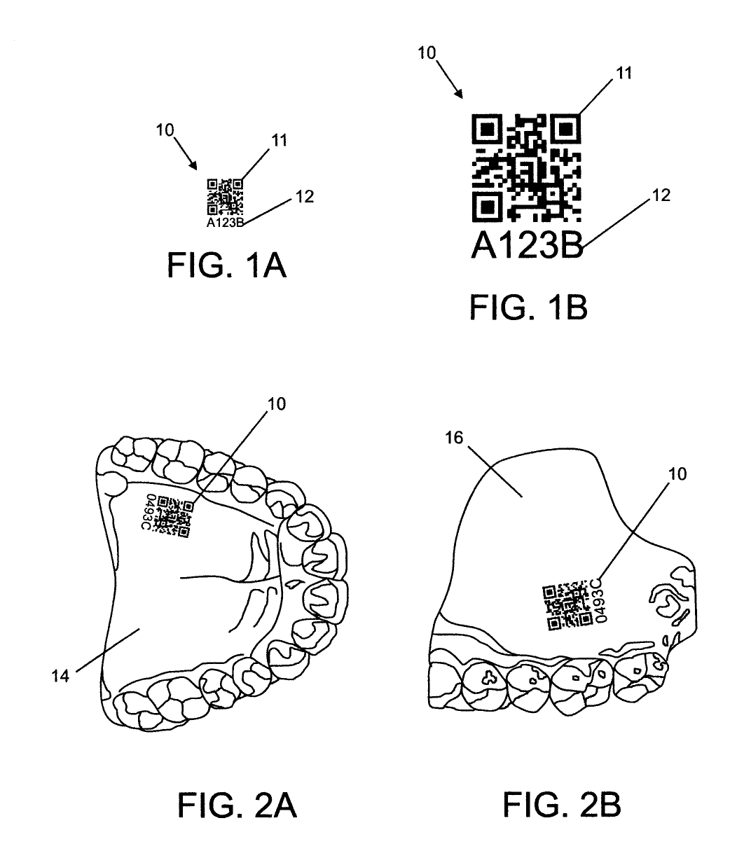

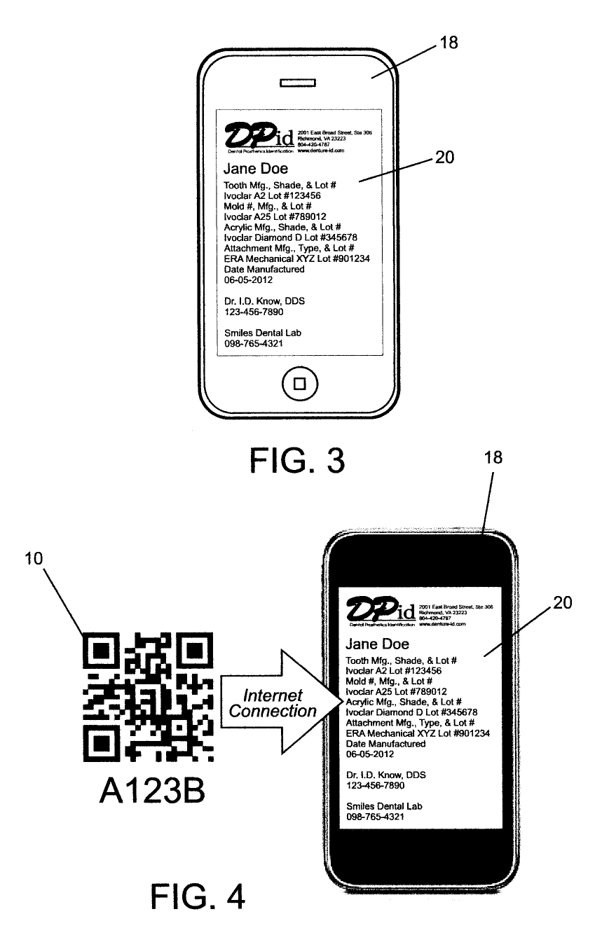

In one embodiment of the DPid Identification System and Method of embodiments of the present invention illustrated in FIG. 1A and FIG. 1B, a label 10 upon which identifying indicia has been printed. In the illustrated embodiment, the identifying indicia comprises a 2D Code 11 and an Identification Number 12. The 2D Code may comprise, for example, a QR Code (illustrated), Microsoft Tag, DataMatrix, BeeTagg, or ShotCode. To provide increased readability, the 2D Code 11 may measure about 5/16″ (9.79 cm)× 7/16″ (13.33 cm) (however, any suitable size label and/or indicia may be used). The 2D code may be printed on the label 10 as a high resolution image of 300 dpi or greater and preferably as a Vector versus a Raster file type. A medium correction level versus a low or high level may be maintained such as a Level of L or Q when using a QR Code along with an adequate “quiet zone.” The 2D Code 11 may be printed on the label 10 in a black ink or other equally contrasting color. The label 10 may comprise a translucent material, and may have an adhesive backing to aid in positioning when being embedded in the dental prosthesis or appliance. The Identification Number assigned in conjunction with the 2D Code may be a 5 digit alpha/numeric code which provides a level of security for Tier 1 data (element 20 in FIG. 3).

Illustrated in FIGS. 2A and FIG. 2B is a typical location for embedding a label 10 having imprinted thereon the 2D Code 11 & Identification Number 12 in an upper denture 14 (FIG. 2A) and section 16 of an upper denture (FIG. 2B). For dental prostheses that can physically accept a label having imprinted thereon a 2D Code & Identification Number, a cavity measuring slightly larger and deeper than the label is to be etched in an inconspicuous location on the prosthesis that is not susceptible to adjustments needed to create a proper fit for the patient. This etching can be done by using any acceptable etching device commonly used in a dental laboratory, such as a Dremel tool. Once the cavity is etched, the label 10 (having imprinted thereon the 2D Code 11 & Identification Number 12) is positioned in the cavity with the adhesive side making contact with the etched area, thereby minimizing movement of the label 10 during over-coating. The label 10 is then over-coated using a clear autopolymerizing acrylic resin or equivalent. Using a clear autopolymerizing acrylic resin or equivalent as an over-coating will allow the natural acrylic color to appear through the translucent adhesive material, but still provide a sufficient contrast making the 2D Code & Identification Number predominant and readable. To increase readability, the clear autopolymerizing acrylic resin may be cured in a pressure pot or other acceptable process to increase clarity of the over-coating and reduce porosity.

Data regarding the specific dental prosthesis bearing the label 10 (which is described in more detail below) may be accessed to facilitate tracking, repair, replacement, etc. Accessing data via the label 10 (having imprinted thereon the 2D Code 11 & Identification Number 12) may require the 2D Code to be scanned by a properly equipped smart phone 18 (FIG. 3) (e.g., iPhone, Android, BlackBerry), electronic tablet computer (e.g., Apple iPad, Motorola Xoom), or other suitable scanning device, preferably equipped with a high resolution megapixel (5 or greater) camera. Any suitable 2D Code reader app may be used, including, but not limited to AT&T (ATT) Code Scanner (also termed ATT Scanner), RedLaser, and i-nigma (the AT&T (ATT) Code Scanner being the preferred reader.

An adequate internet connection (DSL or higher) may be required for the 2D Code 10 to be read and to access and display Tier 1 data 20 on the smart phone 18 or electronic tablet computer (FIG. 4). The data displayed may include, but is not limited to, the materials, components, certifications, government standards, and other related information required to repair, remanufacture, or identify ownership of a dental prosthesis or appliance.

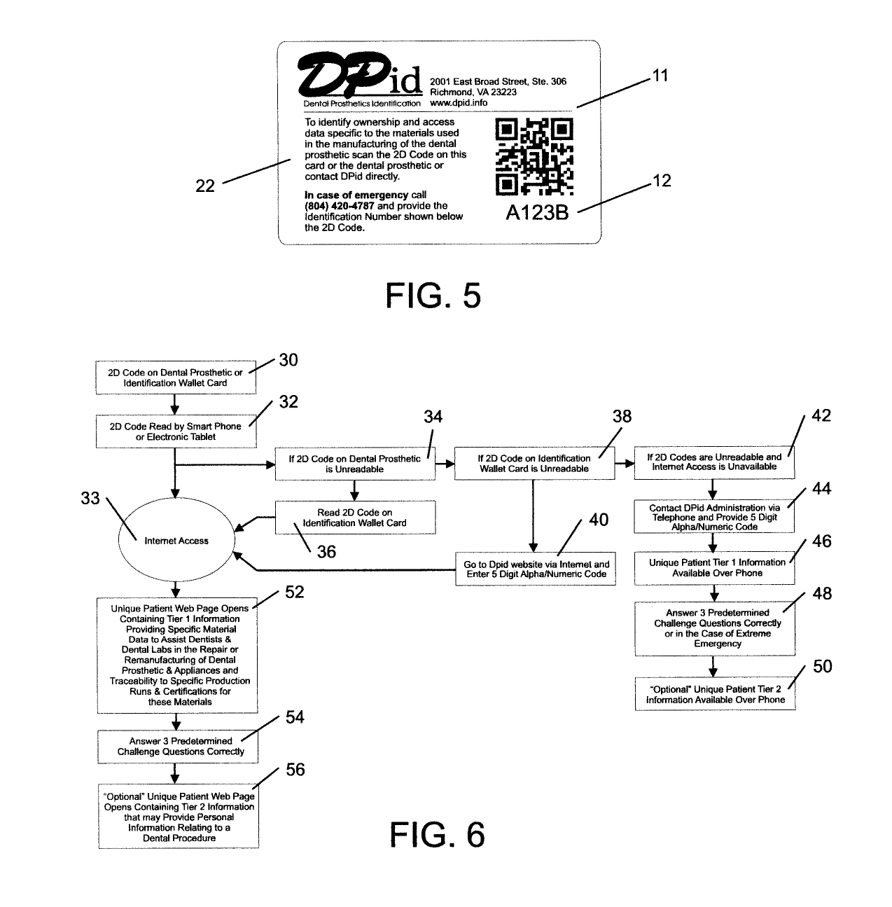

In addition to the 2D Code 10 & Identification Number 12 printed on the label 10 embedded in the dental prosthesis, each patient may be provided an Identification Card 22 (FIG. 5) that is used in cases where a label having imprinted thereon a 2D Code & Identification Number cannot physically be embedded in the dental prosthesis due to space restrictions. Both the embedded label and the Identification Card typically contain identical 2D Codes & Identification Numbers to serve as substitutes for one another in case of failure. The Identification Card 22 includes, but is not limited to the 2D Code 11 & Identification Number 12 and contact information for a service provider that supplies the labels and identification cards and maintains the necessary databases, including a secure website URL and a telephone number.

The process for accessing Tier 1 data 20 (illustrated in FIG. 6) typically begins with accessing the 2D code and/or alpha/numeric Identification Number on a dental prosthetic and/or a patient's identification card (block 30). involves four options: (1) a direct link via the internet by scanning the 2D Code 11 on the dental prosthetic with a properly equipped smart phone 18 or electronic tablet computer (block 32); (2) in case the 2D Code cannot be read (block 34), the 2D code on the Identification Card 22 can be used to access the data (block 36); (3) if neither of the 2D Codes can be read (block 38), the data may be accessed via the internet by going to the secure website URL shown on the Identification Card and entering the 5 digit alpha/numeric Identification Number 12 (typically located beneath the 2D Code) (block 40); and (4) if the 2D Codes are unreadable or if no internet access is available (block 42), data may still be accessible by contacting the service provider via the telephone number on the Identification Card and providing the Identification Number (block 44).

Options 1-3 may be used if internet access is available (block 33). In options 1-3 above, Tier 1 data is accessed after scanning the 2D code or entering the alpha/numeric Identification Number and entering the pre-established password (block 52) (although a patient may elect to have Tier 1 data accessible without entering a password). An additional security screen (such as answering three (or some other number of) predetermined challenge questions (block 54)) is required to access Tier 2 data. Successfully passing the additional security screen enables access to Tier 2 data (block 56).

In option 4 above, Tier 1 data may be provided over the phone to anyone who can furnish the alpha/numeric Identification Number and password (block 46). An additional security screen (such as answering three (or some other number of) predetermined challenge questions (block 48)) is required to access Tier 2 data. Successfully passing the additional security screen enables over-the-phone access to Tier 2 data (block 50).

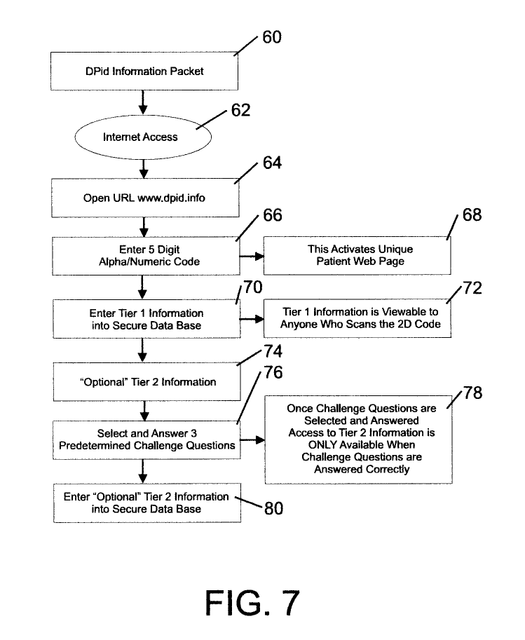

The data for Tier 1 20 and optional Tier 2 data is typically located in one or more databases on one or more secure and encrypted servers and accessible by a secure and encrypted website. The process of initially entering data is illustrated in FIG. 7. The patient will typically receive a DPid Information Packet with access and activation instructions and information regarding the DPid Program (block 60). If the patient has internet access (block 62), the patient can access the service provider's website to set up an account and enter patient Tier 2 data (block 64).

The process of initially entering data for Tier 1 typically requires first entering the unique 5 digit alpha/numeric Identification Number 12 located on both the label to be embedded in the dental prosthesis and on the Identification Card 22 (block 66). Once the Identification Number is entered, the information page appears (block 68) for Tier 1 allowing information for a specific patient to be entered (block 70). Such information typically includes, but is not limited to, the patient's full name, tooth shade and manufacturer, mould number and manufacturer, acrylic shade and manufacturer, attachment application type, number and manufacturer, contact information for manufacturing Dental Laboratory, Dental Laboratory Registration Number, date of manufacture, contact information for Dentist, and Dentist license number. Tier 1 data is openly accessible to anyone who scans the 2D Code and enters the pre-established password (block 72); however, the data can only be initially entered and updated by entering the Identification Number. Optional Tier 2 (block 74) can be accessed by initially selecting and providing answers to challenge questions (there will typically be three challenge questions, all or some of which must be correctly answered) (block 76), at which point the Tier 2 data can be entered (block 80). Subsequent access can only be done by answering all (or some subset of) three challenge questions correctly (block 78) or in the case of extreme emergencies and then only after verification of the inquiry. Tier 2 information may include, but is not limited, to patient's physical address, patient's phone number, patient's email address, health related concerns (such as allergies, dementia, diabetes, medications, etc.) that may directly relate to the application of the dental prosthesis or appliance or dental procedures, emergency contact information, and any other data requested by patient.

From the description above, a number of advantages of some embodiments become evident:

(a) a discrete, economical, simple to install and use 2D Code that uses commonly available smart phones or electronic tablet computers properly equipped with “free” code readers eliminating the need for special reading devices;

(b) rapid access to the materials, components, certifications, government standards, and other related information required to repair, remanufacture, or identify ownership of a dental prosthesis or appliance on a secure and data encrypted website;

(c) providing a concise, encrypted database of information and certifications necessary to meet industry and government regulations and standards assisting in the wellbeing of patients who may require hypoallergenic materials to be used, in addition to providing an ongoing data base for traceability and accountability for the dental prosthetic; and

(d) economical means of providing HIPAA compliant dental prosthesis owner identification, as mandated in 24 states.

Embodiments of the invention may include some or all of the following features:

A. Creation of a unique 2D Code & Identification Number specific to each individual patient comprising:
a. A high resolution image of 300 dpi or greater.
b. Preferably a Vector versus a Raster Output file type limited to an overall size not exceeding approximately 5/16″ (9.79 cm) to 7/16″ (13.33 cm) rectangle.
c. A correction Level of L or Q (based on correction scale of L, Q, M, & H) so as to minimize complexity and increase readability.
d. An adequate “quiet zone” to increase readability
e. Label printed with black ink or equally high contrast ink preferably on an adhesive translucent material to allow it to aesthetically blend-in

B. Insertion of the label with the 2D Code & Identification Number into the dental prostheses or appliance by the following procedure(s):
a. The etching of a rectangular indentation or shallow cavity on an existing dental prosthesis or appliance, in an inconspicuous area, slightly larger than the label with the 2D Code & Identification Number to be embedded.
b. Utilizing a Dental Laboratory approved etching device similar to a Dremel tool equipped with a burr or equivalent etching attachment.
OR
a. Constructing a “spacer” or shallow cavity into the dental prostheses during manufacturing, in an inconspicuous area, slightly larger than the label with the 2D Code & Identification Number to be embedded.

C. Insertion of the label with the 2D Code & Identification Number into the indented area of the dental prostheses or appliance by:
a. Placing the label securely within the indented area allowing sufficient depth/space for a clear overlay.
b. Sealing the label with a clear autopolymerizing acrylic resin over coating, or equal, compatible with the dental prosthesis or appliance material.

D. Reading of 2D Code assigned to the removable dental prosthesis or appliance when removed from the patient's mouth via:
a. A commonly available “free” 2D Code reader applications installed on properly equipped cell phones, electronic digital tablet computers, or any other suitable devices.
b. Ability to recognize and connect, via the internet, to a secure web site URL (either complete or shortened).

E. Obtaining owner identification and manufacturing data of removable dental prosthesis or appliance via:
a. Multi-tiered security protected web site URL with three security levels including, but not limited to, Tier 1 for general information, Tier 2 for sensitive information, and Administrative for emergencies and maintenance. Each Tier is discussed in greater detail below

F. Tier 1 information is “openly” accessible with password by 4 options:
a. Scanning the unique 2D Code embedded in the dental prosthesis or appliance
b. Scanning the identical unique 2D Code on the Identification Card
c. Directly accessing the DPid website and entering the Identification Number
d. Directly calling DPid and providing the Identification Number

G. Tier 1 information may include, but is not limited to the following:
a. Patient's first, middle and last name.
b. Tooth shade, lot number, and manufacturer.
c. Mould number and manufacturer.
d. Acrylic shade, lot number, and manufacturer.
e. Attachment application type, size, number, and manufacturer
f. Contact information for manufacturing Dental Laboratory.
g. Dental Prosthesis country of origin
h. Dental Laboratory Registration Number
i. Date of manufacture
j. Contact information for Dentist
k. Dentist license number
l. Class II Dental Medical Devices
m. Any additional information relating to or necessary for the repair or remanufacturing of the dental prosthesis or appliance

H. Tier 1 information is available by anyone having access to the dental prosthesis or Identification Card containing the unique 2D Code and Identification Number and password, including, but not limited to patient, dentist, dental laboratory, or any business or organization directly involved with ownership identification or repair or remanufacturing of the dental prosthesis or appliance, or Emergency First Responders.
a. Tier 1 information is “read only” and cannot be changed or updated unless the patient's unique Identification Number (5 digit alpha/numeric code next to the QR Code) and password is entered
b. Tier 1 is “read only” by the patient, ONLY the dentist or dental laboratory can change the patient's name and prosthetic data
c. The patient's name (only) in Tier 1 can be provided to a nursing home, hospital administration, or emergency first responder ONLY if the patient “declines” the need for a password

I. Tier 2 information is security question protected and can be accessed ONLY by correctly answering three (or some other number of) pre-selected security questions. However, in the case of “extreme emergency” Tier 2 information can be provided to “identifiable” Emergency First Responders; protocol is outlined under Emergency First Responders Process & Procedure

J. Tier 2 information may include, but is not limited to the following:
a. Patient's physical address
b. Patient's phone number
c. Health related concerns such as allergies, dementia, diabetes, medications, etc. that may relate to the application of the dental prosthesis or appliance or dental procedures
d. Emergency contact information
e. Any other data requested by patient or business
f. Patient's email address

K. As described in Section I, Tier 2 information is accessible ONLY by answering one or more security questions; however, an exception may be made for identifiable Emergency First Responders

L. Tier 2 information can be updated by going to DPid's website and accessing the patient's unique data page by entering the 5 digit alpha/numeric code and then answering the three (or some other number of) security challenge questions
a. It is “strongly” suggested that the answers to the security challenge questions be held confidential by the patient or trusted care provider

M. Emergency First Responders Process & Procedure
a. As stated on the Identification Card and the service provider's website “In case of emergency call (XXX) XXX-XXXX.” A service provider associate will answer and ask for the answers to the patient's pre-selected challenge questions
b. If none of the challenge questions are answered correctly Tier 2 information will NOT be provided
c. However, if an Emergency First Responder calls service provider and identifies themselves as such (police, fire or emergency medical personnel), the service provider associate will ask for their name, badge or employee number, supervisor, and business or organizations contact information
d. The service provider associate will do a quick internet search to confirm any of the information provided and then contact the business or organization provided by the caller to confirm their identity
e. This can be done by either having the caller remain on the line while confirmation is completed or by having the service provider associate call the Emergency First Responder back. Regardless, the service provider associate MUST feel comfortable in providing the information
f. In the case of “extreme” emergency when time is critical, the service provider associate may release “necessary” Tier 2 information to prevent further harm or worse to the patient
g. If the patient “declines” the need for a password, the patient's name (only) will be provided

N. Administrative access to patient's information will be for file maintenance and authorization security for “failed access” due to unreadable 2D Codes, extreme emergencies, or purging, such as removing patients who are deceased or no longer requiring the service.

O. All patient information is encrypted and stored on a secure server meeting requirements for the Health Insurance Portability and Accountability Act (HIPAA). Patient's information is also protected under Personal Privacy and will not be provided to any outside business or organization. Patient information will only be used to provide the absolute best possible service to meet the service provider's customer's needs.

P. Process & Procedure for accessing patient information
a. Simply scan the unique 2D Code on the patient's dental prosthesis or Identification Card linking via the internet to the patient's specific Tier 1 information as described in Section F
b. If the 2D Code is not readable on either the dental prosthesis or Identification Card, the unique Identification Number shown below the 2D Code can be used to access the patient's data when linking directly to DPid's website via the internet
c. If internet access is unavailable then contact service provider at (XXX) XXX-XXXX per Administrative access described in Section N
d. If dental prosthesis or appliance size is not sufficient to allow a 2D Code & Identification Number to be embedded a DPid Identification Card will be provided containing the same information along with service provider contact information.
e. A patient Identification Card will be provided to ALL patients who participate in the DPid program whether or not a 2D Code can be embedded into their dental prosthesis or appliance

The Dental Prostheses Identification Process Flow typically includes:

1. All dental prostheses or appliances MUST include a formal script from a licensed dentist (except as indicated in 1.a below) including dentist's full name, contact information, and dental license number in order for a label with a unique 2D Code & Identification Number to be embedded into the dental prosthesis or appliance.
a. Only a licensed Denturist may manufacture a patient's prosthesis without a dentist's script in certain states.

2. When a patient agrees to participate in the DPid (Dental Prostheses Identification) program, they will be assigned a unique 2D Code & Identification Number. The patient's dentist will typically either send the dental prosthesis or appliance to the dental laboratory for embedding or having the service provider send them a DPid Information Packet containing a unique 2D Code & Patient ID# and Wallet Identification Card for them to embed.

3. The patient will typically receive a DPid Information Packet with access instructions and information regarding the DPid Program from their dentist. Typically only the patient will be authorized to enter the Tier 2 data which is discussed in the DPid Information Packet.

4. Access to Tier 1 and Tier 2 information for dental prostheses or appliances that are not able to accept an embedded 2D Code & Identification Number due to size or other restrictions will typically be accomplished via the Identification Card containing an identical unique 2D Code & Identification Number which will allow the same access and benefits as an embedded 2D Code.

5. Once an account is established by the patient, Dentist, or Dental Laboratory, access is available 24/7 on the service provider's website with an adequate internet connection. This allows changes/updates to the patient's Tier 1 data to occur as the need arises by the dentist or dental laboratory. It is encouraged to make these changes as repairs or changes are made to the patient's dental prosthesis or appliance.

Patient's 2D Code & Identification Number Web Page Activation

To activate a patient's unique 2D Code & Identification Number, Tier 1 and “optional” tier 2 data typically MUST be entered under their Patient Identification Number, typically using a website established for such a purpose.

1. To set-up an account, Internet access will be needed in addition to the answers to the Tier 1 and optional Tier 2 data forms. Set-up should take approximately 10 minutes.

2. The patient's unique website page is primarily designed to benefit the patient, Dentist, and Dental Laboratory by reducing the amount of research that's involved in determining what materials and certifications were used in the manufacturing of the dental prosthesis or appliance. Having this information readily available when repairing or remanufacturing will greatly reduce turn-around time, cost, and reduce or eliminate any potential of harmful materials be introduced to allergenic patients.

3. First go to the service provider's website which is a secure website in which the patient's Tier 1 and Tier 2 data will typically be encrypted for security and where the patient's unique personal 2D Code will link when scanned.

4. Once the service provider's website home page appears, the patient, Dentist, Dental Laboratory or related business will typically be asked to enter the patient's 5 digit alpha/numeric code located next to the 2D Code, found in the DPid Information Packet. Enter the Identification Number and an information page will typically open. It will typically be similar to what's displayed on the Tier 1 data form.

5. The, Dentist or Dental Laboratory may enter the patient's Tier 1 data which relates to specific materials used in the manufacturing of their dental prosthesis or appliance. Although the patient's name will typically appear with this data, the other information is typically specifically for a Dentist or Dental Laboratory to refer when making a repair or complete remanufacture. Remember, the intent is to primarily keep the Tier 1 data as current as possible, so information is available for your Dentist or Dental Laboratory when needed. Regardless who enters the data; they will typically be required to enter the patient's 5 digit alpha/numeric code and password to have access.

6. If the patient desires, “optional” additional information may be entered into Tier 2 . This information is much more sensitive and typically requires a higher level of security. If the Tier 2 data option is utilized, the patient will typically be required to select and provide answers to three challenge questions of their choice from the list of questions provided. This information can typically only be accessed by answering all three (or some other number) of these challenge questions. Only in the case of “extreme emergencies” will this information typically be provided to medical or law enforcement first responders without providing the necessary answers.

7. The patient's information is typically available 24/7 and can be updated any time and as often as necessary.

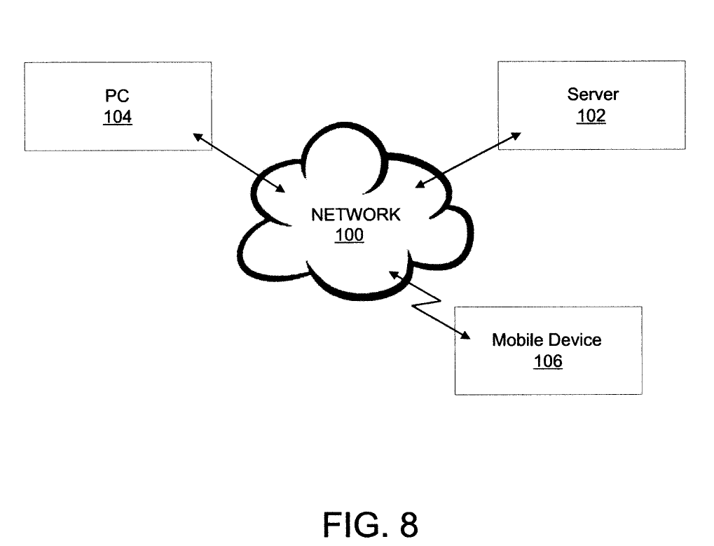

FIG. 8 is a schematic block diagram of a computer network in which embodiments of the present invention may operate. Computer 104, server 102, and mobile device 106 provide processing, storage, and input/output devices executing application programs and the like. Computer 104 may be linked over a communication link through communications network 100 to other computing devices, including server 102. Communications network 100 can be part of the Internet, a worldwide collection of computers, networks, and gateways that currently use the TCP/IP suite of protocols to communicate with one another. The Internet provides a backbone of high-speed data communication lines between major nodes or host computers, consisting of thousands of commercial, government, educational, and other computer networks, that route data and messages. However, computer 104 and server 102 may be linked over any suitable communication network. In the system of FIG. 8, computer 104 may be running a Web browser used for accessing the DPid database, such as may be hosted on server 102. Additionally, mobile device 106 (e.g., a smart phone) may also be in communication with server 102 (either directly accessing network 100, or indirectly accessing network 100 through a mobile telecommunications network (not illustrated). In the system of FIG. 8, mobile device 106 may be running an “app” used for accessing the DPid database, such as may be hosted on server 102.

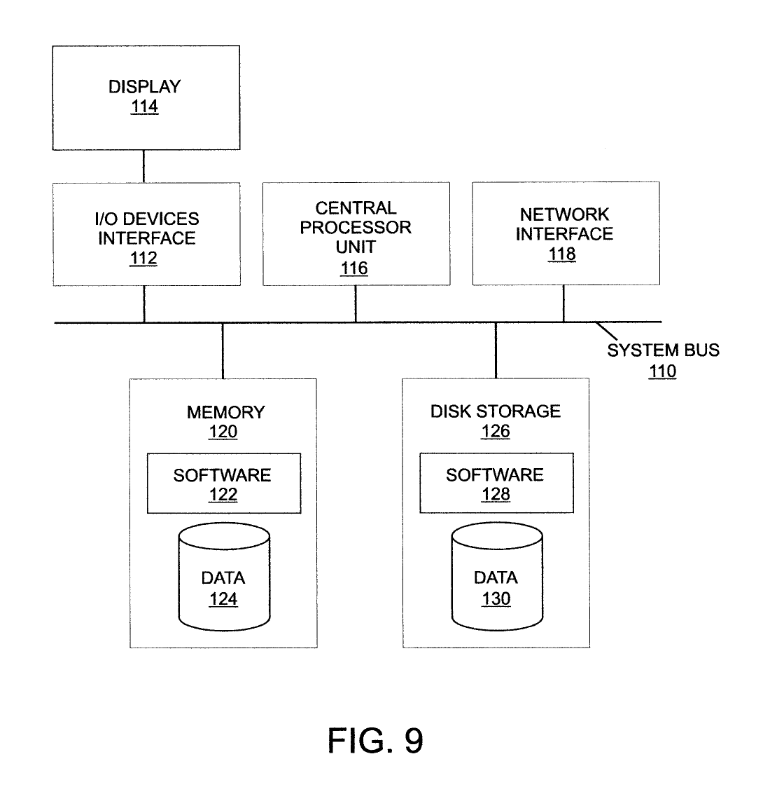

FIG. 9 is a diagram of the internal structure of a computer (e.g., computer 104 or server 102) in the computer network of FIG. 8. Each computer typically contains system bus 110, where a bus is a set of hardware lines used for data transfer among the components of a computer. Bus 110 is essentially a shared conduit that connects different elements of a computer system (e.g., processor, disk storage, memory, input/output ports, network ports, etc.) that enables the transfer of information between the elements. Attached to system bus 110 is I/O device interface 112 for connecting various input and output devices (e.g., displays 114, printers, speakers, etc.) to the computer. Network interface 118 allows the computer to connect to various other devices attached to a network (e.g., network 100 of FIG. 8). Memory 120 provides volatile storage for computer software instructions 122 and data 124 used to implement an embodiment of the present invention. Disk storage 126 provides non-volatile storage for computer software instructions 128 and data 130 used to implement an embodiment of the present invention. Central processor unit 116 is also attached to system bus 110 and provides for the execution of computer instructions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++, Visual Basic, .NET, or the like and conventional procedural programming languages, such as the “C” programming language or similar programming languages. If the service is also available to applications as a REpresentational State Transfer (REST) interface, then launching applications could use a scripting language like JavaScript to access the REST interface. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

“Computer” or “computing device” broadly refers to any kind of device which receives input data, processes that data through computer instructions in a program, and generates output data. Such computer can be a hand-held device, laptop or notebook computer, desktop computer, tablet computer, minicomputer, mainframe, server, cell phone, smartphone, personal digital assistant, other device, or any combination thereof.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A method for storing and accessing information corresponding to a dental prosthesis, the method comprising:
defining a cavity in a surface of a dental prosthesis;
placing a label within the cavity, the label having at least one unique identifying insignia printed thereon;
applying a clear resin over the label; and
curing the applied resin;
wherein defining a cavity within a surface of a dental prosthesis comprises etching a cavity in a previously manufactured dental prosthesis or forming a cavity during manufacture of a dental prosthesis; and
wherein the at least one unique identifying insignia corresponds to a data record specific to the dental prosthesis stored in a secure database.

2. The method of claim 1, wherein the at least one unique identifying insignia comprises a first unique identifying insignia that is machine-readable and a second unique identifying insignia that is human-readable; and
wherein the first and second unique identifying insignia both correspond to the data record specific to the dental prosthesis.

3. The method of claim 2, wherein the first identifying insignia comprises a 2D code, and wherein the second identifying insignia comprises an alphanumeric string.

4. The method of claim 2, further comprising:
reading the first unique identifying insignia with a scanning device adapted to communicate, directly or indirectly, with the secure database to access the data record specific to the dental prosthesis corresponding to the first and second unique identifying insignia.

5. The method of claim 4, wherein the data record specific to the dental prosthesis comprises first tier data and second tier data;
wherein reading the first unique identifying insignia with a scanning device adapted to communicate, directly or indirectly, with the secure database enables access only to the first tier data; and
wherein the method further comprises correctly answering one or more predefined security questions to access the second tier data.

6. The method of claim 2, further comprising:
accessing a website adapted to communicate, directly or indirectly, with the secure database containing the data record specific to the dental prosthesis corresponding to the first and second unique identifying insignia; and
entering the second unique identifying insignia to access the data record specific to the dental prosthesis corresponding to the first and second unique identifying insignia.

7. The method of claim 6, wherein the data record specific to the dental prosthesis comprises first tier data and second tier data;
wherein entering the second unique identifying insignia enables access only to the first tier data; and
wherein the method further comprises correctly answering one or more predefined security questions to access the second tier data.

8. The method of claim 1, further comprising:
providing an identification card having a same at least one unique identifying insignia printed thereon.

9. A system for storing and accessing information corresponding to a dental prosthesis, the system comprising:
a label inserted in a cavity defined in a surface of a dental prosthesis and having a clear resin applied thereover and cured, the label having at least one unique identifying insignia printed thereon; and
a secure database storing a data record corresponding to the at least one unique identifying insignia and specific to the dental prosthesis.

10. The system of claim 9, wherein the at least one unique identifying insignia comprises a first unique identifying insignia that is machine-readable and a second unique identifying insignia that is human-readable; and
wherein the first and second unique identifying insignia both correspond to the data record specific to the dental prosthesis.

11. The system of claim 10, wherein the first identifying insignia comprises a 2D code, and wherein the second identifying insignia comprises an alphanumeric string.

12. The system of claim 10, further comprising:
a scanning device configured to read the first unique identifying insignia and configured to communicate, directly or indirectly, with the secure database to access the data record specific to the dental prosthesis corresponding to the first and second unique identifying insignia.

13. The system of claim 12, wherein the data record specific to the dental prosthesis comprises first tier data and second tier data;
wherein the secure database enables access only to the first tier data when the scanning device reads the first unique identifying insignia and accesses the data record specific to the dental prosthesis corresponding to the first and second unique identifying insignia; and
wherein the secure database enables access to the second tier data when one or more predefined security questions are answered correctly.

14. The system of claim 10, further comprising:
a website adapted to communicate, directly or indirectly, with the secure database containing the data record specific to the dental prosthesis corresponding to the first and second unique identifying insignia;
wherein the website enables a user to enter the second unique identifying insignia to access the data record specific to the dental prosthesis corresponding to the first and second unique identifying insignia.

15. The system of claim 14, wherein the data record specific to the dental prosthesis comprises first tier data and second tier data;
wherein entering the second unique identifying insignia enables access only to the first tier data;
wherein the website prompts the user to answer one or more predefined security questions; and
wherein correctly answering the one or more predefined security questions enables access the second tier data.

16. The system of claim 9, further comprising:
an identification card having a same at least one unique identifying insignia printed thereon.
